(19) United States
(12) Patent Application Publication
(10) Pub. No.: US 2022/0274515 A1
(43) Pub. Date: Sep. 1, 2022

(54) SEAT CUSHION ELEMENT AND VEHICLE SEAT

(71) Applicant: ADIENT US LLC, Plymouth, MI (US)

(72) Inventors: Iain Barlow, Hertfordshire (GB); Frank Dittrich, Bochum (DE); Leonid Fissler, Leverkusen (DE); Jurgen Kuettner, Leverkusen (DE); Francois Mougin, Barr (FR)

(73) Assignee: ADIENT US LLC, Plymouth, MI (US)

(21) Appl. No.: 17/631,978

(22) PCT Filed: Aug. 3, 2020
(86) PCT No.: PCT/EP2020/071828

§ 371 Date: Feb. 1, 2022

(30) Foreign Application Priority Data
Aug. 5, 2019 (DE) 10 2019 211 726.0
Feb. 28, 2020 (DE) 10 2020 104 233.7

(51) Int. Cl. B60N 2/58

(52) U.S. Cl. CPC B60N 2/5825

(57) ABSTRACT

A seat cushion element may have at least one cushion element, a cover fastening mechanism and a cover element. The cushion element, the cover fastening mechanism and the cover element may form a pre-mounted unit and are arrangeable as such on a seat structure. The cover fastening mechanism may be premounted on a bottom side of the cushion element in a recess of the cushion element and the cover element may be arranged on a top side of the cushion element and is connected to the cover fastening mechanism through the cushion element. The cover element may have a connecting device by which the pre-mounted unit can be finally assembled on the seat structure. A vehicle seat having such a seat cushion element may also be made.

The invention relates to a seat cushion element comprising a cushion element, a cover fastening mechanism and a cover element. Furthermore, the invention relates to a vehicle seat having at least a seat structure and a seat cushion element arranged on the seat structure.

Vehicle seats comprising a seat backrest and a seat part are known from the prior art, wherein the seat part comprises a seat structure or a seat frame and a seat cushion, to which a cover element is usually fastened.

By way of example, DE 10 2009 023 586 A1 discloses a vehicle seat arrangement having a seat part and a seat cushion.

It is the object of the present invention to specify a seat cushion element, in particular for a vehicle seat, said seat cushion element being improved in relation to the prior art and comprising at least a cushion element, a cover fastening mechanism and a cover element, and also an improved vehicle seat.

With regard to the seat cushion element, the object is achieved according to the invention by the features specified in claim 1. With regard to the vehicle seat, the object is achieved according to the invention by the features specified in claim 15.

Advantageous configurations of the invention are the subject matter of the dependent claims.

A seat cushion element according to the invention comprises at least a cushion element, a cover fastening mechanism and a cover element, wherein the cushion element, the cover fastening mechanism and the cover element form a pre-assembled unit and can be arranged as such on a seat structure. The cover fastening mechanism is pre-assembled on an underside of the cushion element, in a cutout of the cushion element, and the cover element is arranged on a top side of the cushion element, said top side lying opposite the underside, and is connected to the fastening mechanism through the cushion element, wherein the cover element has connecting means by which the pre-assembled unit can be finally assembled on the seat structure.

The advantages obtained with the invention are in particular that a seat cushion element formed in this way can be pre-assembled in a simple manner and is positioned in the form of a pre-assembled unit on, for example, an existing or additionally produced seat structure, in particular a seat frame, a backrest frame, a seat shell or backrest shell, and finally assembled. In particular, components of the seat cushion element are adapted to one another such that a pre-assembly operation is relatively simple, cost-effective and time-saving. The dimensions of the cushion element are preferably adapted to the seat structure. The dimensions of the cover element are preferably adapted to the cushion element and to the seat structure.

The connecting of the pre-assembled unit to the seat structure via the cover element, in particular via the connecting means thereof, permits a largely rapid and simple final assembly operation. During the final assembly operation, the underside of the cushion element is placed into or onto the seat structure. For example, the cover fastening mechanism is received in the cutout of the cushion element in such a way that the cover fastening mechanism terminates in a largely planar manner, in particular level, with the underside of the cushion element. This for example makes it possible to keep the cushion element as stable and comfortable as possible during the action of force. For example, the cover fastening mechanism is arranged completely in the cutout. By way of example, an underside of the cover fastening mechanism terminates flush with a surface side, for example the underside, of the cushion element.

In a refinement, the cover fastening mechanism is arranged in the cutout and at least partially surrounded by it. This for example makes it possible for the cushion element to yield during the action of force in the region of the cover fastening mechanism, wherein the cover fastening mechanism is not perceptible to an occupant when sitting.

The cutout is formed on the underside of the cushion element and is accessible through the underside for the purpose of pre-assembling and arranging the cover fastening mechanism. The cover element completely covers the top side of the cushion element and for example has peripheral cover extensions which completely envelope the periphery of the cushion element. The cover extensions are formed in such a way that they at least peripherally embed the seat structure and can be connected by the connecting means to the seat structure.

Depending on the configuration of the seat structure or on customer requirements, the seat cushion element and the components thereof, i.e. cushion element, cover fastening mechanism and cover element, can be produced individually. It is for example possible for at least the cover fastening mechanism to be produced by what is known as a Just-in-Time production method.

In a refinement, the pre-assembled unit is enveloped on both sides by the cover element and the cover fastening mechanism. As a result of the cover fastening mechanism being received within the cushion element, in particular on the underside thereof, the cushion element, the cover fastening mechanism and the cover element form a unit that is firmly fixed together. In particular, the cushion element is surrounded on both sides, i.e. at least on the top side and on the underside, by the cover element and cover fastening mechanism. The cutout has a receiving form which corresponds to the cover fastening mechanism and in which the cover fastening mechanism is completely received. For example, the receiving form is designed in such a way that the cover fastening mechanism is completely fixed, i.e. pre-positioned and pre-assembled, in said form. By way of example, the cover fastening mechanism is releasably fixed, clipped or plugged into the receiving form.

In other words: the pre-assembled unit is formed from a cushion element, on which a cover fastening mechanism is pre-assembled in a cutout on one of the surface sides, in particular on an underside, and a cover element is arranged on a surface side lying opposite this surface side, in particular a top side, and is connected to the cover fastening mechanism through the cushion element, and thus pre-assembled. Such a pre-assembled unit comprising a cushion element which is enveloped on both sides by the cover element and the cover fastening mechanism can be assembled as an assembly part on a seat structure, in particular a seat frame or a seat shell, in a simple manner, for example by mechanical connection of the cover element to the seat structure, for example by mounting of protruding, in particular peripheral, cover extensions in receptacles on the seat structure.

The cover fastening mechanism is preferably arranged completely in the cutout of the cushion element, and the cover element envelopes at least the top side and peripheral sides of the cushion element.

In addition, the cover fastening mechanism can also be pre-assembled in a simple manner, wherein the plurality of fastening means for fastening of the cover element can be arranged into the cushion element, in particular at a predefined spacing from one another, in a rapid and precise manner.

In a possible configuration, the pre-assembled unit has a cover fastening mechanism which is pre-fixed to the cushion element at least in a direction of longitudinal extent and direction of transverse extent thereof. Furthermore, the pre-assembled unit has a cover element which is fixed to the pre-fixed cover fastening mechanism. In particular, the cover fastening mechanism is pre-fixed to the cushion element at least in a direction of longitudinal extent and in a direction of transverse extent thereof and is fixed to the cushion element in a direction of vertical extent thereof by fastening of the cover element to the cushion element, i.e. the cover element is retained on the cushion element, and fastened to the cover fastening mechanism, in such a way that at least the cover fastening mechanism is fixed to the cushion element in a direction of vertical extent thereof.

In a further configuration, the cover fastening mechanism comprises a number of fastening means for a cover element of a vehicle seat which are arranged one after the other and connected to one another via at least one connecting means. In particular, the cover fastening mechanism is of chain-like form. The cover fastening mechanism has the form of a chain. The chain form can be designed in any desired manner. By way of example, the cover fastening mechanism has a U form, O form or L form. It is also possible for a plurality of cover fastening mechanisms to be formed.

The cover fastening mechanism is configured in the form of fastening means which are spaced apart in succession and connected to one another.

In other words: the cover fastening mechanism is configured in the form of a fastening chain. The individual fastening means are configured for example in the form of rapid fastening means, such as for example clip elements, in particular spring clips or clip clamps. Alternatively, the fastening means may comprise other suitable form-fitting and/or force-fitting fastening receptacles for correspondingly designed counterpart fastening elements.

In a possible embodiment, the fastening means are connected to one another for example by a flexible connecting means, such as a band, a rod, a chain or similar. The flexible connecting means is in particular formed from a plastics material or a thin metal material. In this case, the connecting means is of flexible design such that it maintains an assumed or laid form, such as a rounding or curve, and thus has a sufficient dimensional stability. In this way, the cover fastening mechanism can be laid in curves, arches, roundings, bevels, corners and/or edges in a cushion element. By way of example, the fastening means are adhesively bonded to, plugged onto or molded onto the connecting means.

In a refinement, the cover element has counterpart fastening means which correspond to the cover fastening mechanism. The counterpart fastening means are arrested on the cover element, for example. Alternatively or in addition, the counterpart fastening means project from an underside of the cover element, said underside lying opposite the top side of the cushion element. The counterpart fastening means can be plugged into, in particular automatically arrested in, the fastening means.

In a further embodiment, the cutout has at least one receiving channel in which the at least one connecting means of the cover fastening mechanism is arranged. In this case, the channel has the same chain form as that of the cover fastening mechanism.

In a further possible embodiment, the cutout has a number of mutually spaced-apart receiving chambers having passage openings in which the fastening means of the cover fastening mechanism are arranged. A respective chamber form corresponds to the form of the respective fastening means. The receiving chambers are provided for the purpose of pre-fixing and pre-assembling the fastening means. The passage openings extend vertically through the cushion element. The counterpart fastening means arranged on the cover element are guided through the passage openings in order to come into latching connection with the fastening means of the cover fastening mechanism.

In a possible configuration, the cover element has at least one cover extension having cohesive, force-fitting and/or form-fitting connecting means. After pre-assembly of the pre-assembled unit, the cover extension can be placed around peripheral sides of the cushion element so as to cover them. The pre-assembled unit can be fastened, in particular finally assembled, on the seat structure by cohesive, force-fitting and/or form-fitting connection of the cover element.

A vehicle seat according to the invention comprises at least a seat structure and a seat cushion element according to the preceding description which is arranged on or at or in the seat structure, wherein the seat cushion element, in the form of a pre-assembled unit, is finally assembled and fastened on the seat structure by cohesive, force-fitting and/or form-fitting connection of the cover element. The seat structure, in particular a frame or a shell, has counterpart receptacles which correspond to the connecting means arranged on the cover element.

Furthermore, an assembly apparatus according to the invention for pre-assembly of the seat cushion element, in particular for fastening of a cover element to a cushion element of the vehicle seat, is proposed, wherein the assembly apparatus comprises an assembly form having a number of fixing elements, on which the cover fastening mechanism can be releasably fixed for assembly with a cushion element and for fastening to a cover element.

When cushion element, cover fastening mechanism and cover element are being assembled, the cover fastening mechanism is firstly releasably fixed, in particular pre-fixed, to the assembly form by the fixing elements, and the cushion element is then placed by way of its receiving channel and receiving chambers on its underside onto the cover fastening mechanism in such a way that the fastening means of said cover fastening mechanism are at least partially arranged in the passage openings and/or in the receiving chambers, and also the connecting means of said cover fastening mechanism are arranged in the receiving channel, in such a way that, during the subsequent attachment of the cover element, the counterpart fastening means are connected through the passage openings and/or within the latter to the fastening means in a form-fitting and/or force-fitting manner, wherein in particular an automatic clip connection, latching connection or snap-fit connection is produced in each case.

Exemplary embodiments of the invention will be discussed in more detail with reference to drawings, in which:

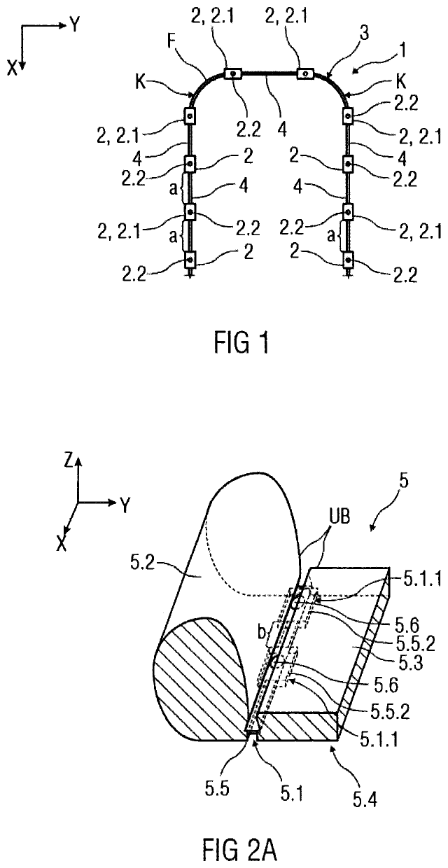

FIG. 1 schematically shows a plan view of an embodiment of a cover fastening mechanism,

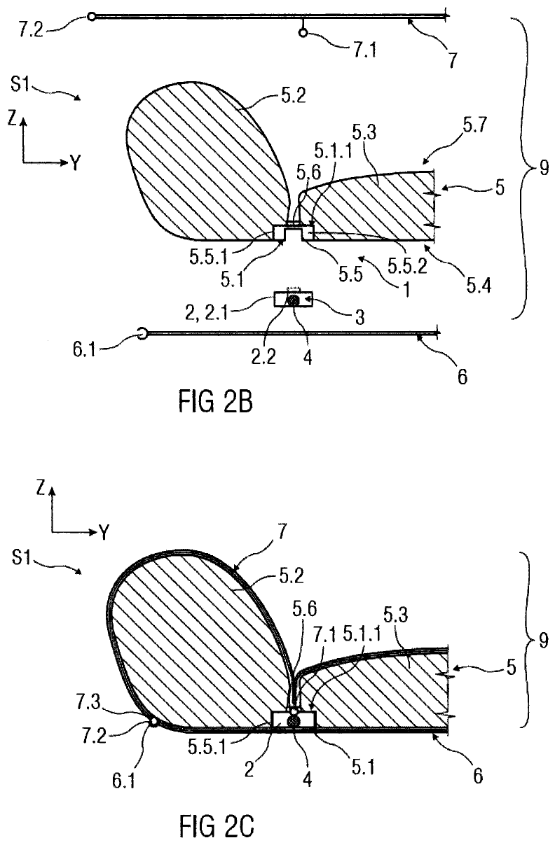

FIG. 2A schematically shows a perspective and partially transparent illustration of a cushion element with a receiving channel for a cover fastening mechanism,

FIG. 2B schematically shows an exploded illustration of a seat cushion element having at least one cushion element with a receiving channel, receiving chambers and passage openings for receiving a cover fastening mechanism for a cover element,

FIG. 2C schematically shows a sectional illustration of a seat cushion element having at least one cushion element with a receiving channel, receiving chambers and passage openings for receiving a cover fastening mechanism for a cover element,

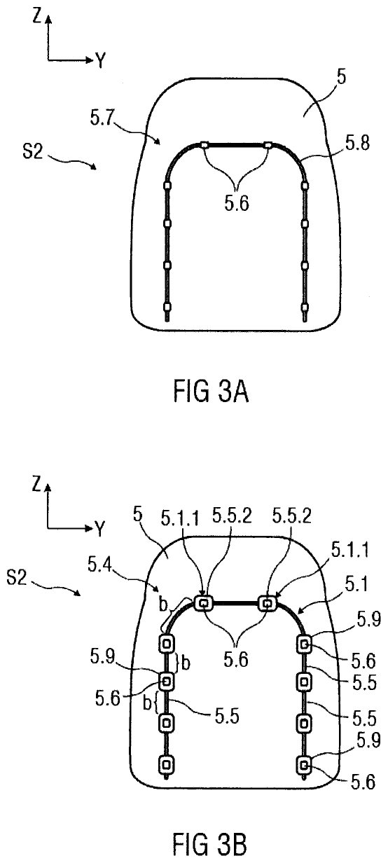

FIG. 3A schematically shows a front view of a cushion element with a receiving channel for a cover fastening mechanism,

FIG. 3B schematically shows a rear view of a cushion element with a receiving channel for a cover fastening mechanism,

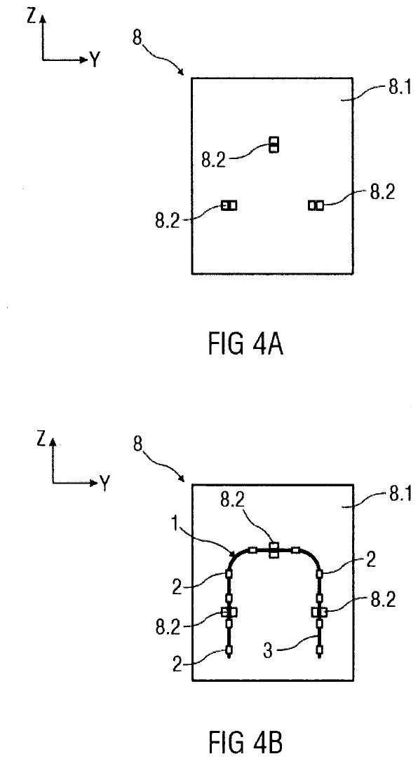

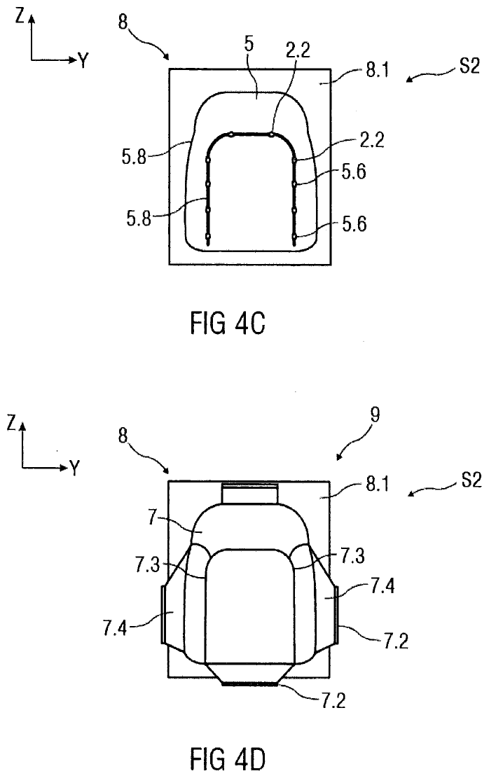

FIG. 4A schematically shows an assembly apparatus in a method step of a method for pre-assembly of cushion element, cover fastening mechanism and cover element,

FIG. 4B schematically shows an assembly apparatus in a further method step of the method for pre-assembly of cushion element, cover fastening mechanism and cover element,

FIG. 4C schematically shows an assembly apparatus in a further method step of the method for pre-assembly of cushion element, cover fastening mechanism and cover element,

FIG. 4D schematically shows an assembly apparatus in a further method step of the method for pre-assembly of cushion element, cover fastening mechanism and cover element, and

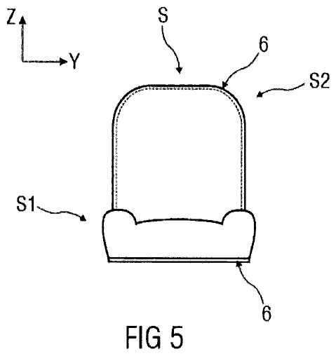

FIG. 5 schematically shows a vehicle seat having a seat structure and a seat cushion element arranged thereon comprising a cushion element, a cover fastening mechanism and a cover element, which together form a pre-assembled unit.

Parts which correspond to one another are denoted by the same reference designations in all figures.

FIG. 1 schematically shows a plan view of an embodiment of a cover fastening mechanism 1. The cover fastening mechanism 1 is configured in the form of fastening means 2 which are arranged one after the other and connected to one another. In particular, the cover fastening mechanism 1 is configured in the form of a fastening chain 3.

For improved understanding, a coordinate system is shown in each case in the figures, the coordinate system comprising a longitudinal axis X, a transverse axis Y and a vertical axis Z in relation to the vehicle seat S (shown in FIG. 5). The vehicle seat S is arranged, for example, in a vehicle or aircraft and is oriented in the direction of travel.

The individual fastening means 2 are configured for example in the form of rapid fastening means, such as for example clip elements, in particular spring clips or clip clamps. Alternatively, the fastening means 2 may be configured in the form of another suitable form-fitting and/or force-fitting fastening receptacle, for example a latching connection or snap-fit receptacle. In this case, all the fastening means 2 of the fastening chain 3 can be of identical design. Alternatively, different fastening means 2 may be provided along the longitudinal extent of the fastening chain 3. By way of example, it is possible for relatively strong fastening means 2, such as latching hooks or clip hooks, to be provided in regions that are subjected to strong mechanical loading and for latching clamps or clip clamps to be provided in regions subjected to less intense loading.

For example, the fastening means 2 each have a base body 2.1. Fastening elements 2.2 are arranged on the base body 2.1. The fastening means 2 are of one-part design, for example. By way of example, the respective base body 2.1 and the respective fastening element 2.2 are formed from one piece, in particular are of one-part design. In this case, the base body 2.1 and the fastening element 2.2 can be produced by an injection-molding process, for example. Alternatively, the fastening means 2 are of two-part or multiple-part design. By way of example, the respective fastening element 2.2 is arrested on the respective base body 2.1 in a cohesive, force-fitting and/or form-fitting manner. The respective fastening element 2.2 projects from the respective base body 2.1, for example. In a refinement, the fastening element 2.2 is recessed in the base body 2.1. The base body 2.1 is for example configured to position and fix, in particular pre-position and pre-fix, the fastening means 2 in a cushion element 5 shown in FIG. 2A. The fastening element 2.2 is for example a rapid fastening element, such as a latching element, a clamp element or a clip element. The fastening element 2.2 is for example a fastening receptacle, such as a latching receptacle, snap-fit receptacle or plug-in receptacle, for fixing a counterpart fastening means 7.1 which is arranged, for example, on a cover element 7 shown in FIGS. 2B and 2C to the cushion element 5.

In a possible embodiment, the fastening means 2 are connected to one another for example by a flexible connecting means 4. The flexible connecting means 4 is configured for example in the form of a flexible band, a flexible rod, a flexible chain or another suitable means. The flexible connecting means 4 is in particular formed from a plastics material or a thin metal material. In this case, the connecting means 4 is of flexible design such that it maintains an assumed or laid form F, such as a rounding or curve K, and thus has a sufficient dimensional stability. This makes it possible for the cover fastening mechanism 1 to be laid in curves K, arches, roundings, bevels, corners and/or edges.

The connecting means 4 can be used to arrange the fastening means 2 at a predefined fixed spacing a from one another. In this case, all the fastening means 2 can be arranged at an identical spacing a from one another. Alternatively, the spacing a may vary along the longitudinal extent of the fastening chain 3. It is for instance possible for the fastening means 2 to be arranged at various spacings a from one another. By way of example, the spacing a between two fastening means 2 in the region of a curve K can be smaller than in a rectilinear region of the fastening chain 3, or vice versa. In particular, it is possible for more fastening means 2 with relatively small spacings a from one another to be provided in curved regions of the fastening chain 3 than in rectilinear regions of the fastening chain 3 having fewer fastening means 2 with relatively great spacings a from one another.

FIG. 2A schematically shows a perspective and partially transparent illustration of a cushion element 5 with a cutout 5.1 for receiving the cover fastening mechanism 1, as is shown for example in FIG. 1.

The cushion element 5 can be of one-part or multiple-part design. In the exemplary embodiment shown, the cushion element 5 is of two-part design and comprises a side bolster cushion element 5.2 and a seat surface cushion element 5.3.

In this case, the cutout 5.1 has a receiving form which corresponds to the cover fastening mechanism 1. In a possible embodiment, the cushion element 5 has, on one of the surface sides, in particular on an inner side or underside 5.4, a receiving channel 5.5 which is provided along its longitudinal extent with a number of mutually spaced-apart passage openings 5.6 in which the fastening means 2 of the cover fastening mechanism 1 can be or are arranged in the assembled state.

In a possible embodiment, the number of passage openings 5.6 of the receiving channel 5.5 corresponds to the number of fastening means 2 of the cover fastening mechanism 1, in particular of the fastening chain 3. For example, the passage openings 5.6 are designed to be complementary to the fastening means 2 and have in particular a form and/or dimensions that correspond to a form and/or dimensions of the fastening means 2.

For example, the cutout 5.1 has a number of receiving chambers 5.1.1. The respective receiving chamber 5.1.1 has a form which corresponds to the form of the respective base body 2.1 of the fastening means 2. In this case, the receiving chambers 5.1.1 are designed for example as mutually spaced-apart receiving portions 5.5.2 which are enlarged relative to the receiving channel 5.5. The cutout 5.1 thus comprises a receiving channel 5.5 and receiving chambers 5.1.1 or receiving portions 5.5.2 which are arranged in succession along the receiving channel 5.5. The respective receiving chambers 5.1.1 are arranged at fixed spacings b from one another, which correspond to the spacings a of the fastening means 2. Furthermore, passage openings 5.6 are formed on the cushion element 5 in the region of the respective receiving chambers 5.1.1. In this case, the respective receiving chamber 5.1.1 has a passage opening 5.6 through which the counterpart fastening means 7.1 arranged on the cover element 7 are guided in a pre-assembled state of the cushion element 5, the cover fastening mechanism 1 and the cover element 7.

In a possible embodiment, the respective fastening element 2.2, which projects from the respective base body 2.1, can be arranged (FIG. 2B) or is arranged (shown in FIG. 2C) partially or completely in the passage opening 5.6 in the pre-assembled state of the cushion element 5, the cover fastening mechanism 1 and the cover element 7. For example, the fastening means 2, in particular the base bodies 2.1 thereof, are fastened in the respective receiving chamber 5.1.1 in a force-fitting, form-fitting and/or cohesive manner. The respective receiving chamber 5.1.1 has, for example, a coating by which the respective fastening means 2 can be or is fixed in the respective receiving chamber 5.1.1 in a releasable or non-releasable manner. In the pre-assembled state of the cushion element 5, the cover fastening mechanism 1 and the cover element 7, the connecting means 4 is embedded partially or completely in the receiving channel 5.5. The receiving channel 5.5 has, for example, a coating by which the connecting means 4 is fixed in the receiving channel 5.5 in a releasable or non-releasable manner. In particular, the cushion element 5, the cover fastening mechanism 1 and the cover element 7 form a pre-assembled unit 9. In this case, the cover fastening mechanism 1 is pre-fixed to the cushion element 5 at least in a direction of longitudinal extent and in a direction of transverse extent thereof.

As a result of the fastening of the cover element 7 to the cushion element 5, the cover fastening mechanism 1 is also fixed to the cushion element 5 in a direction of vertical extent thereof. In this case, counterpart fastening elements 7.1 arranged on the cover element 7 are at least partially guided through the cushion element 5, in particular through the passage openings 5.6, and brought into fixing engagement, for example latching engagement or snap-fit engagement or clip engagement, with the fastening means 2. Furthermore, the cover element 7 is fixedly retained on the cushion element 5 by the cover fastening mechanism 1.

In a possible embodiment, the number of receiving chambers 5.1.1 or receiving portions 5.5.2 corresponds to the number of fastening means 2 of the cover fastening mechanism 1, in particular of the fastening chain 3. For example, the receiving chambers 5.1.1 and the passage openings 5.6 are designed to be complementary to the fastening means 2 and have in particular a form and/or dimensions that correspond to a form and/or dimensions of the fastening means 2.

For example, the receiving channel 5.5 is introduced on the underside 5.4 into the cushion element 5 in a transition region UB between side bolster cushion element 5.2 and seat surface cushion element 5.3.

The receiving channel 5.5 has, between in each case two adjacent passage openings 5.6, a form and/or dimensions that correspond to a form and/or dimensions of the connecting means 4 of the cover fastening mechanism 1, in particular of the fastening chain 3.

FIGS. 2B and 2C schematically show, in the region of one of the passage openings 5.6, an exploded illustration and sectional illustration, respectively, of the cushion element 5 with the receiving channel 5.5, the receiving chambers 5.1.1 and the passage openings 5.6 for receiving the cover fastening mechanism 1 for fastening of a cover element 7.

The cover fastening mechanism 1 can be arranged (FIG. 2B) or is arranged (FIG. 2C) in the cutout 5.1 in such a way that the fastening means 2 which can be or are arranged in the receiving chambers 5.1.1 are accessible from above for corresponding counterpart fastening means 7.1 of the cover element 7. In particular, the fastening means 2 for corresponding counterpart fastening means 7.1 are accessible through the passage openings 5.6 and optionally additionally through the fastening elements 2.2, which can be or are arranged in the passage openings 5.6, on the surface side, in particular an outer side or top side 5.7, of the cushion element 5 facing away from the receiving channel 5.5. The fastening means 2 and the counterpart fastening means 7.1 form a fastening apparatus for the cover element 7.

The passage openings 5.6 preferably have a form and/or dimension that is at least partially smaller than the form and/or dimension of the respective fastening element 2.2. In this way, in the assembled state, as shown in FIG. 2C, in which the counterpart fastening means 7.1 is retained in the associated fastening means 2 in a form-fitting and/or force-fitting manner, for example in a snap-fit, latched-in or clipped manner, the respective fastening element 2.2 can be retained, in particular retained in a pulled or preloaded manner, against a channel bottom 5.5.1 of the receiving channel 5.5 in the region of the passage opening 5.6.

In this way, in an assembled state in which the counterpart fastening means 7.1 of the cover element 7 are connected in a form-fitting and/or force-fitting manner to the fastening means 2 of the cover fastening mechanism 1, in particular of the fastening chain 3, partially in the passage openings 5.6 and/or in the receiving channel 5.5, the cover fastening mechanism 1 is securely fixed and retained in the cushion element 5 and the cover element 7 is securely fixed and retained on the cushion element 5, as is shown in FIG. 2C.

The cover element 7 is connected through the cushion element 5 to the cover fastening mechanism 1. The components that are pre-assembled with one another—cushion element 5, cover fastening mechanism 1 and cover element 7—form a pre-assembled unit 9 in the assembled or put-together state.

The pre-assembled unit 9 in particular comprises the cushion element 5 on which the cover fastening mechanism 1 is pre-assembled in the cutout 5.1 on the underside 5.4, and the cover element 7 is arranged on the top side 5.7, wherein the cover fastening mechanism 1 is connected through the cushion element 5 to the cover element 7.

The pre-assembled unit 9 forms a separate seat cushion element S1, S2 which is independent of a seat structure 6, as illustrated in FIG. 5. The seat cushion element S1 is a seat surface cushion, and the seat cushion element S2 is a backrest cushion.

In particular, the seat cushion element S1, S2 is a pre-assembled unit 9 composed of three parts. The pre-assembled unit 9 has parts that are at least mechanically connected to one another. It is possible to dispense with additional connecting elements, such as adhesive elements or screw elements, for the assembly of the pre-assembled unit 9. The cover fastening mechanism 1 and the cover element 7 are fixedly retained on one another and on the cushion element 5 by the releasable mechanical connection between the fastening means 2 and the counterpart fastening means 7.1. For the purpose of exchanging, servicing and/or repairing seat structure parts or seat cushion parts, the pre-assembled unit 9 can be removed from a seat structure 6, and can possibly have its individual parts disassembled, in a simple and rapid manner. Due to the simple and parts-saving solution of the seat cushion element S1, S2, the seat cushion element S1, S2 can be of largely thin or narrow design, wherein the cushion element 5 affords a sufficient level of comfort.

A pre-assembled unit 9 comprising the cushion element 5 which is enveloped on both sides by the cover element 7 and the cover fastening mechanism 1 can be assembled as an assembly part on a seat structure 6, in particular a seat frame or a seat shell, in a simple manner. By way of example, the pre-assembled unit 9 can be finally assembled and fastened on the seat structure 6 by mechanical connection of the cover element 7 to the seat structure 6, for example by mounting of protruding, in particular peripheral, cover extensions 7.4, in particular of connecting means 7.2, in a counterpart receptacle 6.1, for example in a receiving groove on the seat structure 6.

In addition, the cushion element 5 can be/is arranged and can be/is fastened to a seat structure 6. In this case, the cover element 7 can have at least one connecting means 7.2 at its periphery, by which connecting means the cover element 7 is peripherally connected to the seat structure 6 in addition to the internal fastening to the cushion element 5. The seat structure 6 is configured for example in the form of a conventional carrier frame or a conventional carrier shell, which have corresponding counterpart receptacles 6.1 for the form-fitting and/or force-fitting, in particular releasable, fastening of the connecting means 7.2.

For improved clarity, only one half of a seat cushion element S1, in particular of a vehicle seat S, is shown in FIGS. 2A to 2C. FIGS. 3A and 3B show a backrest of a vehicle seat S as seat cushion element S2, and the entire receiving possibility for the cover fastening mechanism 1, in particular a U-shaped cover fastening mechanism 1.

FIGS. 3A and 3B schematically show a front view and a rear view, respectively, of the cushion element 5 with the receiving channel 5.5 and the passage openings 5.6 for the cover fastening mechanism 1.

The cushion element 5 is in particular a foam cushion element. The cushion element 5 has, on its underside 5.4, the receiving channel 5.5 having the passage openings 5.6 for the fastening chain 3. On the front side or top side 5.7, the cushion element 5 can additionally have a trim channel 5.8.

The fastening apparatus, consisting of fastening means 2 and counterpart fastening means 7.1, is at least partially arranged within the trim channel 5.8 and/or receiving channel 5.5. In particular, the fastening means 2 and/or the counterpart fastening means 7.1 are at least partially arranged within a trim channel 5.8 or the receiving channel 5.5.

The cushion element 5 has, on the top side 5.7 and on the underside 5.4, a respective groove, which form the trim channel 5.8 and the receiving channel 5.5, respectively. The thickness of the cushion element 5 is in particular smaller than the depths of the trim channel 5.8 and of the receiving channel 5.5.

The passage openings 5.6 are each provided, on the underside 5.4 in the region of the receiving channel 5.5, with a border 5.9 which is introduced into the underside 5.4 in the form of an indentation in order to be able to receive a respective one of the fastening means 2.

FIGS. 4A to 4D schematically show an assembly apparatus 8 and a sequence of a method for assembling cushion element 5, cover fastening mechanism 1 and cover element 7.

The assembly apparatus 8 comprises an assembly form 8.1 having a number of fixing elements 8.2, on which the cover fastening mechanism 1 can be releasably fixed for assembly with the cushion element 5 and for fastening of the cover element 7 on the cushion element 5.

When cushion element 5, cover fastening mechanism 1 and cover element 7 are being assembled, the cover fastening mechanism 1, in particular the fastening chain 3, is firstly releasably fixed to the assembly form 8.1 by the fixing elements 8.2. The cushion element 5 is then placed by way of its receiving channel 5.5 and the receiving chambers 5.1.1 on its underside 5.4 onto the cover fastening mechanism 1 in such a way that the fastening means 2 are at least partially arranged in the receiving chambers 5.1.1 and/or in the passage openings 5.6, and the connecting means 4 are arranged in the receiving channel 5.5, in such a way that, during the subsequent attachment of the cover element 7, the counterpart fastening means 7.1 are connected through the passage openings 5.6 and/or partially within the passage openings 5.6 to the fastening means 2 in a form-fitting and/or force-fitting manner, wherein in particular a clip connection, latching connection or snap-fit connection is produced in each case, for example by compressive force.

A cover fold 7.3 forms along the profile of the cover fastening mechanism 1 by which the cover element 7 is fastened to the cushion element 5.

FIG. 5 schematically shows a vehicle seat S having seat structures 6, comprising a backrest structure and a seat surface structure, and a respective seat cushion element S1, S2 arranged on the respective seat structure 6. The respective seat cushion element S1, S2 is formed from a cushion element 5, a cover fastening mechanism 1 and a cover element 7 and is at least mechanically connected in the form of a pre-assembled unit 9 to the respective seat structure 6.

### LIST OF REFERENCE DESIGNATIONS

1 Cover fastening mechanism
2 Fastening means
2.1 Base body
2.2 Fastening element
3 Fastening chain
4 Connecting means
5 Cushion element
5.1 Cutout
5.1.1 Receiving chamber
5.2 Side bolster cushion element
5.3 Seat surface cushion element
5.4 Underside
5.5 Receiving channel
5.5.1 Channel bottom
5.5.2 Receiving portion
5.6 Passage opening
5.7 Top side
5.8 Trim channel
5.9 Border
6 Seat structure
6.1 Counterpart receptacles
7 Cover element
7.1 Counterpart fastening means
7.2 Connecting means
7.3 Cover fold
7.4 Cover extension
8 Assembly apparatus
8.1 Assembly form
8.2 Fixing element
9 Pre-assembled unit
a, b Spacing
F Laying form
K Curve
S Vehicle seat
S1, S2 Seat cushion element
UB Transition region
X Longitudinal axis
Y Transverse axis
Z Vertical axis

1-15. (canceled)

16. A seat cushion element, comprising:
a cushion element,
a cover fastening mechanism and
a cover element,
wherein the cushion element, the cover fastening mechanism and the cover element form a pre-assembled unit and can be arranged as such on a seat structure,
wherein the cover fastening mechanism is pre-assembled on an underside of the cushion element, in a cutout of the cushion element, and the cover element is arranged on a top side of the cushion element and is connected to the cover fastening mechanism through the cushion element,
wherein the cover element has a connecting device by which the pre-assembled unit can be finally assembled on the seat structure.

17. The seat cushion element as claimed in claim 16, wherein the pre-assembled unit has a cover fastening mechanism which is pre-fixed to the cushion element at least in a direction of longitudinal extent and/or direction of transverse extent thereof.

18. The seat cushion element as claimed in claim 16, wherein the cutout is formed on the underside of the cushion element and is accessible through the underside for the purpose of pre-assembling and arranging the cover fastening mechanism.

19. The seat cushion element as claimed in claim 16, wherein the cover element is fastened to the cushion element and to the cover fastening mechanism in such a way that at least the cover fastening mechanism is fixed to the cushion element in a direction of vertical extent thereof.

20. The seat cushion element as claimed in claim 16, wherein the cutout has a receiving form which corresponds to the cover fastening mechanism and in which the cover fastening mechanism is received.

21. The seat cushion element as claimed in claim 20, wherein the cover fastening mechanism is arranged in the cutout and at least partially surrounded by it.

22. The seat cushion element as claimed in claim 21, wherein the cover fastening mechanism is releasably fixed, clipped or plugged into the receiving form.

23. The seat cushion element as claimed in claim 16, wherein the cover fastening mechanism comprises a number of fastening devices which are arranged one after the other and connected to one another via at least one connecting device.

24. The seat cushion element as claimed in claim 16, wherein the cutout has at least one receiving channel in which the at least one connecting device of the cover fastening mechanism is arranged.

25. The seat cushion element as claimed in claim 16, wherein the cover element has a counterpart fastening device which corresponds to the cover fastening mechanism.

26. The seat cushion element as claimed in claim 16, wherein the cutout has at least a number of mutually spaced-apart receiving chambers having passage openings in which a fastening device of the cover fastening mechanism is arranged.

27. The seat cushion element as claimed in claim 16, wherein the cushion element is surrounded by at least the top side and the underside, by the cover element and by the cover fastening mechanism.

28. The seat cushion element as claimed in claim 16, wherein the cover element completely covers the top side of the cushion element and has peripheral cover extensions which completely envelope the periphery of the cushion element.

29. The seat cushion element as claimed in claim 16, wherein the cover element has at least one cover extension having a force-fitting and/or form-fitting connecting device.

30. A vehicle seat having at least a seat structure and a seat cushion element as claimed in claim 16 which is arranged on the seat structure, wherein the seat cushion element, in the form of a pre-assembled unit, is finally assembled and fastened on the seat structure at least by force-fitting and/or form-fitting connection of the cover element to said seat structure.
